(19) United States
(12) Patent Application Publication
(10) Pub. No.: US 2013/0168305 A1
(43) Pub. Date: Jul. 4, 2013

(54) DEVICE FOR TREATING A LIQUID

(71) Applicants: Josef Taszarek, Taunusstein (DE); Uwe Lang, Taunusstein (DE); Adrian Eck, Eltville am Rhein (DE); Maria Festner, Wiesbaden (DE); Stefan Hother, Wiesbaden (DE); Marcus Horn, Wiesbaden (DE); Tobias Schuler, Dreieich (DE); Thomas Hagen, Mainz (DE)

(72) Inventors: Josef Taszarek, Taunusstein (DE); Uwe Lang, Taunusstein (DE); Adrian Eck, Eltville am Rhein (DE); Maria Festner, Wiesbaden (DE); Stefan Hother, Wiesbaden (DE); Marcus Horn, Wiesbaden (DE); Tobias Schuler, Dreieich (DE); Thomas Hagen, Mainz (DE)

(21) Appl. No.: 13/823,272

(22) PCT Filed: Sep. 28, 2011
(86) PCT No.: PCT/EP2011/066817

§ 371 Date: Mar. 14, 2013

(30) Foreign Application Priority Data
Sep. 29, 2010 (DE) 10 2010 041 667.3

(51) Int. Cl. B01D 35/30

(52) U.S. Cl. CPC B01D 35/30
USPC 210/232; 137/15.01

(57) ABSTRACT

A device for treating a liquid, including a container for collecting the liquid to be treated, including a first fastening unit which has the property that the unit develops a force of attraction under the action of a magnet or has the property of a magnet, and a cartridge for treating the liquid and which can be detachably fastened to the container, including a second fastening unit which has the property that the unit develops a force of attraction under the action of a magnet or has the property of a magnet. The first fastening unit and the second fastening unit interact such that the cartridge can be detachably fastened to the container.

### FIELD OF THE INVENTION

The present invention relates to an apparatus for treating a liquid, comprising a receptacle for collecting the liquid to be treated and a cartridge for treating the liquid, attachable to the receptacle in a releasable manner. Furthermore, the pre sent invention relates to a corresponding receptacle and a corresponding cartridge, as well as to a method for releasably attaching the cartridge to the receptacle.

### BACKGROUND OF THE INVENTION

In the following, the invention will be explained with reference to the treatment of water, the treatment of drinking water taken from the mains water supply being primarily concerned. In principle, however, any liquid, and in particular water-based liquids, can be treated with the cartridge according to the present invention.

Cartridges for processing a liquid, and in particular water, include treatment means, by which the water can be processed. These treatment means are, for example, ion exchange and/or activated carbon materials, by means of which the water is chemically and/or physically treated. The treatment means have only a limited capacity, however, so that the cartridges must be replaced at regular intervals in order to ensure effective treatment of the water.

In gravity-driven apparatuses for treating water, the cartridges are often inserted in an opening in a bottom wall of a receptacle. The water can be filled into the receptacle and collected there before it flows into the cartridge and is treated. In gravity-driven apparatuses the receptacle is often referred to as a funnel. To ensure that all the water filled into the receptacle is treated, the cartridge must be inserted into the bottom wall of the receptacle in a liquid-tight manner. A liquid-tight seal in the present context is to be understood as a seal that to a large extent prevents passage of the liquid through the seal used, so that the desired application can be duly carried out. One hundred percent sealing need not necessarily be aspired to. A certain degree of leakage of the liquid may be acceptable, depending on the application. When a cartridge is replaced, it frequently happens that the new cartridge is not properly inserted into the bottom wall of the receptacle and thus not in a liquid-tight manner, as a result of which, at least a portion of the liquid flows past the cartridge and thus only a portion of the water filled into the receptacle is treated.

DE 10 2004 026 188 proposes a cartridge and an apparatus for filtering liquids enabling the user to determine the correct and thus liquid-tight fit of the cartridge in the receptacle. Herein, the cartridge snaps into place in a manner discernible by the user. This approach is well proven, but it involves a certain additional expenditure of material and manufacture.

### SUMMARY OF THE INVENTION

It is thus an object of the present invention to develop further the apparatus mentioned initially in such a manner that the cartridge is connectable to the receptacle with low material and manufacturing expenditure and with few and simple hand movements in a releasable and liquid-tight manner.

The object is achieved by an apparatus of the type mentioned initially, wherein the receptacle includes a first magnetic or magnetised attachment unit and the cartridge includes a second magnetic or magnetised attachment unit, wherein the first attachment unit and the second attachment unit co-operate in such a manner that the cartridge is attachable to the receptacle in a releasable manner. In the present context, a magnetic attachment unit is an attachment unit which generates a force of attraction under the action of a magnet. A magnetised attachment unit is characterised in that it itself exhibits the properties of a magnet, i.e. it attracts magnetic objects.

The first attachment unit is available at low costs and can be applied at any desired position on the receptacle so that it does not appreciably make the manufacture of the receptacle more difficult or expensive. For example, it can also be applied adhesively or screwed on. The only precondition is that the second attachment unit of the cartridge co-operate sufficiently with the first attachment unit. In gravity-driven apparatuses, the first attachment unit must be able to exert a force on the second attachment unit of the cartridge that is larger than the weight of the cartridge and any other forces acting on the cartridge. The first attachment unit attracts the second attachment unit of the cartridge to the receptacle or vice-versa as soon as the cartridge is brought close enough to the receptacle. Furthermore, the cartridge is positioned on the receptacle through the co-operation of the first attachment unit with the second attachment unit, so that the user need only bring the cartridge close enough to the receptacle to attach it to the latter. Further steps are not necessary for attachment. To separate the cartridge from the receptacle, the user need only exert a correspondingly large counter force directed against the action of the force acting between the first and the second attachment unit. The apparatus according to the invention thus allows for simple replacement of the cartridge. It must be noted however, that the receptacle itself is usually not magnetic or magnetised, with the exception of the first attachment unit, and the cartridge itself is not magnetic or magnetised, with the exception of the second attachment unit, since they are predominantly made of plastic material.

In pressure-driven apparatuses for the treatment of water, the same effects occur to the same extent, even if the cartridge is usually assembled in a housing, which fixes the cartridge at least partially in a shape-locked manner. Therefore, the first and the second attachment units do not necessarily have to be able to transfer the entire weight of the cartridge. A smaller force may be sufficient, depending on the assembly situation of the cartridge in the apparatus. In pressure-driven apparatuses, the receptacle is often also referred to as a tank.

In a further embodiment of the apparatus according to the invention, wherein the receptacle comprises a first sealing element and/or the cartridge comprises a second sealing element, the first attachment unit and the second attachment unit co-operate in such a manner and are adapted to the first and/or the second sealing element in such a manner that the cartridge is sealable in a liquid-tight manner with respect to the receptacle. Herein, relatively soft sealing elements can be used, which are compressed to a relatively large extent to seal the cartridge in a liquid-tight manner with respect to the receptacle. Herein, the first attachment unit and the second attachment unit need only exert relatively small forces of attraction on each other. Alternatively, relatively hard sealing elements can be used, where a relatively small displacement is sufficient for sealing. In this case, however, larger forces of attraction must act between the first attachment unit and the second attachment unit. In any case it is achieved that the water to be treated can only flow into the cartridge and not past it.

In a further development of the apparatus according, to the invention, the first attachment unit is arranged centrally on the receptacle. The central arrangement enables a symmetric and even a rotationally symmetric construction of the receptacle, which is advantageous from the point of view of design and manufacture, since fewer limiting conditions of the arrangement have to be taken into consideration, which leads to reduced manufacturing costs for the receptacle.

In an embodiment, the first attachment unit is arranged in a bottom wall of the receptacle. In gravity-driven apparatuses for the treatment of liquids, an outlet opening is usually provided in the bottom wall, through which the liquid present in the receptacle is released into the cartridge arranged below the receptacle. The arrangement of the first attachment unit in the bottom wall has the effect that the distance to the cartridge can be reduced. The force exerted by the first attachment unit decreases with the distance from the first attachment unit. The force acting on the cartridge will be larger, the closer the cartridge can be brought to the first attachment unit. Consequently, the first attachment unit can be made smaller in dimension and thus be provided in a more cost-effective manner.

In an embodiment, the first attachment unit is entirely surrounded by the material of the bottom wall. Damage to the first attachment unit caused by external influences is thus reduced. For example, it is prevented that the first attachment unit contacts the liquid to be treated, by which it could be damaged, such as through corrosion. Furthermore, it is ensured that the first attachment unit is fixedly connected to the receptacle and cannot loosen and drop out of the receptacle. The material of the bottom wall itself is non-magnetic and, as already mentioned above, usually consists of plastic material. It is also possible, however, to make the first attachment unit tree of the material of the bottom wall towards the funnel, so that the distance to the second attachment unit can be increased, thereby decreasing the force of attraction. It is also possible, however, to make the first attachment unit free of the material of the bottom wall towards the cartridge, whereby the distance to the second attachment unit can be reduced, which leads to an increased force of attraction. Herein, the first attachment unit can also be applied adhesively or screwed onto the receptacle.

In an embodiment of the apparatus according to the invention, in which the receptacle includes an outlet opening for releasing the liquid to be treated from the receptacle, the outlet opening at, least partially surrounds the first attachment unit. In this way, the outlet opening can be provided with a large cross-sectional area through which the water can flow, so that undesirable throttling losses can be kept small.

In a further embodiment of the apparatus according to the invention, wherein the receptacle includes an outlet opening for releasing the liquid to be treated from the receptacle, the first attachment unit at least partially surrounds the outlet opening. The outlet opening can be formed, for example, as a central through-bore through the bottom wall of the receptacle, which is simple and thus cost-effective from the point of view of manufacture. Furthermore, in this embodiment, a large surface area is available to the first attachment unit so that the force generated by it can be increased.

In an embodiment, the first attachment unit includes a first magnet having a circular annular cross-section. Magnets of this shape have the effect that they exert a rotationally symmetric force, so that the cartridge need not be installed on the receptacle in a certain rotational position, which facilitates attachment and release of the cartridge.

in an embodiment, the first attachment unit comprises several first magnets. For certain applications it is desirable to attach the cartridge on the receptacle in only a certain rotational position, for example when the cartridge is not provided with a rotationally symmetric cross section, but is provided with an elliptical or polygonal cross-section. The desired rotational position of the cartridge can be prescribed by the position of the first magnets.

A particular embodiment of the apparatus according to the invention is characterised by one or more positioning means for determining the position of the cartridge relative to the receptacle. The positioning means can be in the form of, for example, a circumferential rim protruding from the bottom wall, or it can be two opposing protrusions on the bottom wall of the receptacle. If two opposing protrusions that are not linked to each other are present, the position of the cartridge relative to the receptacle is not defined unequivocally, but they give the user guidance so that he can approximately estimate the position in which the cartridge must be brought to attach it to the receptacle. Two protrusions are advantageous if cartridges having different, sizes are to be attached to the receptacle. For example, a cartridge having a circular cross-section can be attached just as much as a cartridge with a non-rotationally symmetric cross-section, as long as one of its diameters corresponds to the distance between the two protrusions. A circumferential rim is advantageous if the cartridge is to be attached to the receptacle in only a certain rotational position, for example with non-rotationally symmetric cross-sections, wherein the circumferential rim delineates the same curve as the edge of the cartridge.

In an embodiment, the second attachment unit comprises one or more second magnets and/or one or more bodies with the property that it or they develops or develop a force of attraction under the influence of a magnet. In case the second attachment unit includes the second magnet, it is already magnetised before it is brought into the vicinity of the first attachment unit. In this way large forces can be transferred between the second attachment unit and the first attachment unit, although it must be kept in mind that the polarity of the second attachment unit is chosen to be the opposite of the polarity of the first attachment unit, since otherwise repelling forces will act. If the second attachment unit comprises a body susceptible of being magnetised, the polarity need not be considered, and, furthermore, the body can be obtained at low-er costs. If the second attachment unit comprises the second magnet and the body, a certain rotational position of the cartridge relative to the receptacle can be prescribed, and, at the same time, large forces can be transmitted.

In an embodiment, the body comprises a metal or a metal alloy. It may in particular consist of a metal or metal alloy. The body can thus be made in a cost-effective manner. Through the selection of the metal or the metal alloy the size of the force of attraction between the second attachment unit and the first attachment unit can be determined. Iron, in particular martensitic steels, nickel or cobalt, come into consideration as the metal. Metal alloys can be alloys on the basis of
iron, nickel and cobalt in crystalline or amorphous form,
nickel-zinc,
manganese-zinc,
cobalt-samarium,
neodymium-iron-boron,
aluminium-zinc-cobalt,
barium-strontium,
platinum-cobalt,
copper-nickel-iron,
copper-nickel-cobalt,
iron-cobalt-chromium, or
manganese-aluminium-carbon.

The apparatus according to the present invention may further be characterised in that the second attachment unit is arranged centrally on the receptacle. The central arrangement enables a symmetric or even a rotationally symmetric construction of the cartridge, which is advantageous from a structural and manufacturing point of view, since fewer limiting conditions of the arrangement have to be considered, which leads to reduced manufacturing costs for the cartridge.

The second attachment unit may be arranged in a top wall of the cartridge. In gravity-driven apparatuses for treating liquids, an outlet opening is usually provided in the bottom wail, through which the liquid present in the receptacle is released into the cartridge arranged below the receptacle. The arrangement of the second attachment unit in the top wall has the effect that the distance of the second attachment unit to the receptacle can be reduced. The force exerted by the first attachment unit decreases with the distance to the first attachment unit. The smaller the distance from the second attachment unit to the first attachment unit, the larger the force created by the first attachment unit becomes. Consequently, the first attachment unit and the second attachment unit can be made smaller in dimension and therefore provided in a more cost-effective manner. However, it is also possible to equip the top wall of the cartridge in pressure-driven apparatuses with the second attachment unit according to the invention.

In an embodiment, the second attachment unit is completely surrounded by the material of the top wall. Damage to the second attachment unit caused by external influences is, reduced. It is, for example, prevented that the second attachment unit contacts the liquid to be treated, in which way it could be damaged, such as through corrosion. Furthermore, it is ensured that the second attachment unit is fixedly connected to the cartridge and cannot loosen and drop out of the receptacle.

However, it is also possible to make the second attachment unit free of the material of the top wall towards the receptacle, by means of which the distance to the first attachment unit can be reduced, which leads to an increased force of attraction. Herein, the second attachment unit can also be adhesively applied or screwed to the cartridge.

The second attachment unit may have a circular annular cross section. The second attachment unit formed in such a way has the effect that it exerts a force that is rotationally symmetric, so that the cartridge need not be attached to the receptacle in a particular rotational position, which facilitates attachment and release of the cartridge.

A further aspect of the present invention concerns a receptacle for collecting a liquid to be treated, provided with a first attachment unit according to any one of the embodiments explained above for releasably attaching a cartridge for treating liquid to the receptacle. The effects discussed above apply equally to the receptacle.

A further aspect of the present invention concerns a cartridge for treating a liquid, having a second attachment unit according to any one of the embodiments explained above. The effects discussed above apply equally to the cartridge according to the invention.

The object underlying the invention is also achieved by a method of releasably attaching a cartridge for treating water to a receptacle for collecting the water to be treated, having the following steps:
providing a receptacle for collecting the liquid to be treated having a first attachment unit with the property, that it develops a force of attraction under the influence of a magnet or with the property of a magnet;
providing a cartridge for treating the liquid having a second attachment unit with the property, that it develops a force of attraction under the influence of a magnet or with the property of a magnet; and
releasably connecting the cartridge to the receptacle by means of the first attachment unit and the second attachment unit.

The effects resulting from this method correspond to those set out for the receptacle according to the invention, the cartridge according to the invention, and the apparatus for treating a liquid according to the invention.

There is therefore disclosed below the use of a first and second attachment unit according to any one of the preceding embodiments for releasably connecting a cartridge for treating a liquid to a receptacle for collecting the liquid to be treated.

### BRIEF DESCRIPTION OF THE DRAWINGS

The invention will be explained in detail in the following with reference to the appended drawings referring to preferred embodiments, wherein:

FIG. 1 is a sketch of the principles of an apparatus according to the invention according to a first embodiment for treating a liquid having a receptacle according to the invention and a cartridge according to the invention, wherein the cartridge is not attached to the receptacle,

FIG. 2 is a sketch of the principles of the apparatus according to the invention according to the first embodiment for treating a liquid of a receptacle and of a cartridge, wherein the cartridge is attached to the receptacle,

FIG. 3 is a sectional view of the first embodiment along the sectional plane X-X defined in FIG. 1,

FIG. 4 is a sectional view of a second embodiment of the apparatus according to the invention along the lines of the sectional plane X-X defined in FIG. 1, and

FIG. 5 is a sectional view of a third embodiment of the apparatus according to the invention along the lines of the sectional plane X-X defined in FIG. 1.

### DETAILED DESCRIPTION OF THE INVENTION

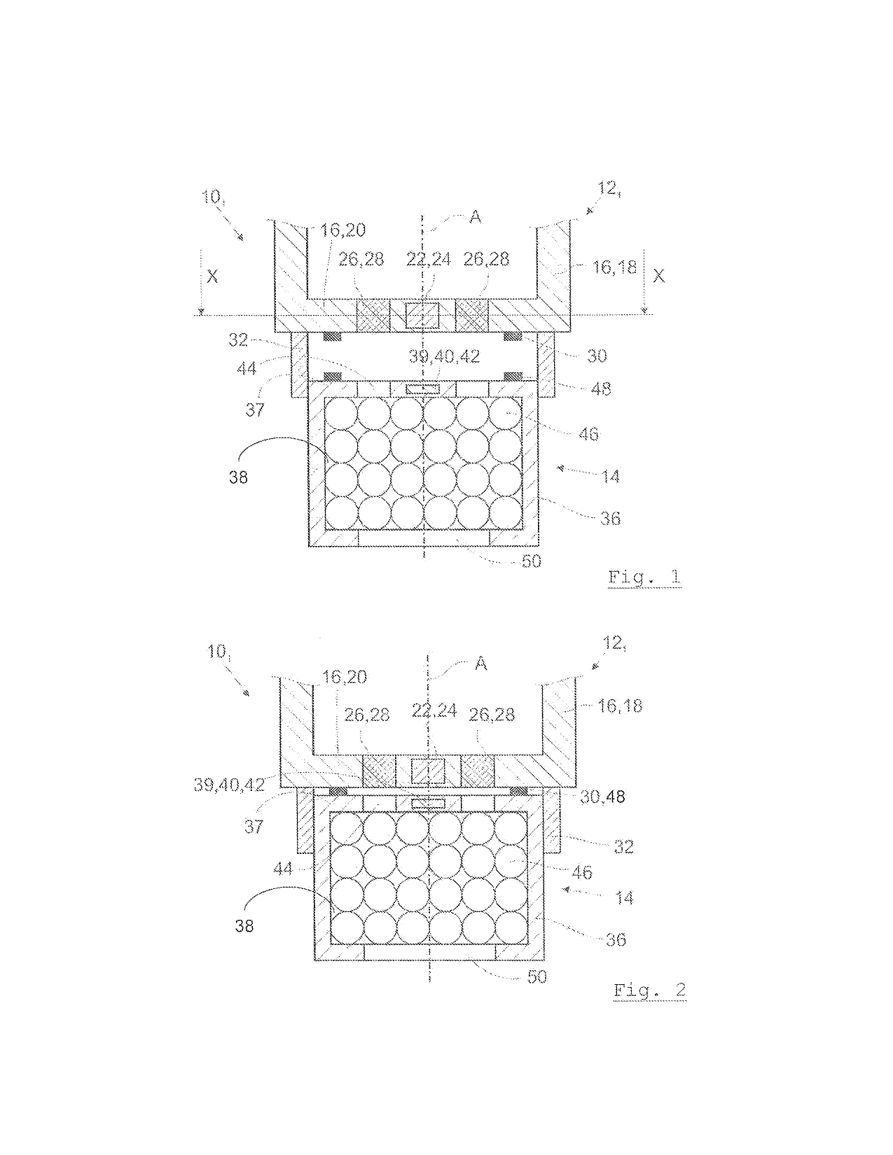

In FIG. 1, a first embodiment of the apparatus 10₁ for treating a liquid according to the invention, comprising a receptacle 12₁ and a cartridge 14, is shown by means of a conceptual sketch. The liquid to be treated can be filled into the receptacle 12, and collected there. The receptacle 12₁, shown only partially, comprises a surrounding wall 16 including a side wall 18 and a bottom wall 20. In the bottom wall 20, a first attachment unit 22, which is completely enveloped by the material of bottom wail 20, is arranged, wherein the first attachment unit 22 can of course also extend completely through the bottom wall 20. The first attachment unit 22 can also be completely free of the material of the bottom wall 20 towards the cartridge 14, and can be glued or screwed to the receptacle 12₁. The first attachment, unit 22 comprises a first magnet 24, which is arranged centrally with respect to a longitudinal axis A of the receptacle 12₁.

Furthermore, outlet openings 26, which are provided with a grating 28, are provided in the bottom wall 20. The grating 28 ensures that coarse-grained contaminants in the liquid to be treated are retained and cannot leave the receptacle 12₁ through the outlet openings 26. The outlet openings 26 at least partially surround the first attachment unit 22 (cf. FIG. 3).

Furthermore, a first sealing element 30 is provided on the outside of the bottom wall 20, which seals the cartridge 14 with respect to the receptacle 12₁ and prevents untreated liquid from leaking out on the side between the cartridge 14 and receptacle 12₁ and getting into the filtrate.

The receptacle 12₁ also comprises a positioning means 32 with which the position of the cartridge 14 relative to the receptacle 12₁ can be determined. In this example, the positioning means 32 is formed as a circumferential rim on the bottom wall 20, with other configurations also being conceivable. The positioning means 32 can also be provided on the cartridge 14 and embrace the receptacle 12₁ at its side wall 18.

The cartridge 14 is provided with a housing 36 having a top wall 37 defining an interior space 38. In the top wall 37, a second attachment unit 39, which is completely surrounded by the material of the top wall 37, is arranged. Alternatively, the second attachment unit 39 can extend completely through the top wall 37, or it can be made free of the material of the top wall 37 towards the receptacle 12₁, and it can be screwed or glued onto the cartridge 14. The second attachment unit 39 comprises a second magnet 40 and/or a magnetic body 42. Furthermore, an inlet opening 44 is provided in the top wall 37, through which the liquid to be treated, and in particular the water, passes into the interior space 38 of the cartridge 14, where treatment means 46 are present, with which the water is treated in, for example, a chemical or physical manner. The cartridge 14 comprises a second sealing element 48 that ensures that untreated water does not leak into the filtrate when the cartridge 14 is attached to the receptacle 12₁ (cf. FIG. 2). Furthermore, the cartridge 14 comprises an outlet 50 via which the treated water can be drained.

In FIG. 2, the cartridge 14 is attached to the receptacle 12₁. To this end, the cartridge 14 and the receptacle 12₁ are aligned flush along a longitudinal axis A, for which purpose the positioning means 32 are provided. Subsequently, the cartridge 14 is moved along the longitudinal axis in such a way that the distance between the bottom wall 20 and the top wall 37 is reduced. The force of attraction acting between the first attachment unit 22 and the second attachment unit 39 increases as the distance between the bottom wall 20 and the top wall 37 is reduced. Once the distance falls below a certain value, the force of attraction is greater than the gravitational force acting on the cartridge 14, so that the cartridge 14 is attracted to the receptacle 12₁ and eventually abuts the latter. At the same time, the first and second sealing elements 30, 48 are pressed against each other so that the cartridge 14 is sealed in a liquid-tight manner with respect to the receptacle 12₁. The liquid to be treated can now be filled into the receptacle 12₁ from which it flows through the outlet, openings 26 of the receptacle 12₁ into the inlet openings 44 of the cartridge 14. From there, the liquid passes into the interior space 38 of the cartridge 14 and flows through the treatment means 46. Subsequently, the treated liquid leaves the cartridge 14 via the outlet 50.

In FIG. 3, the apparatus 10₁ according to the invention in accordance with a first embodiment is shown by way of a sectional view along the sectional plane X-X defined in FIG. 1. The sectional plane X-X extends through the bottom wall 20 of the receptacle 12₁. The outlet openings 26, in each of which a grating 28 is inserted, are recognisable. The first attachment unit 22 is arranged centrally, has a circular cross section and is partially surrounded by the outlet, openings 26.

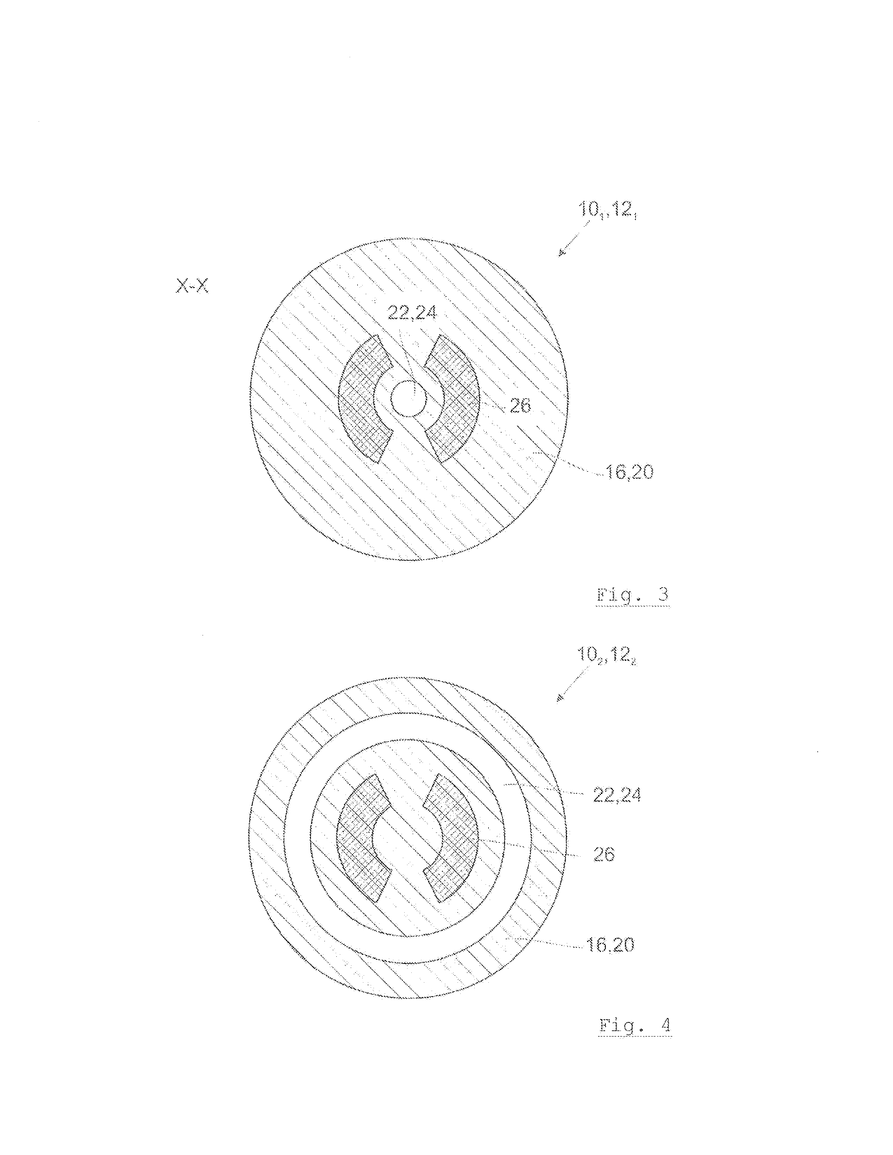

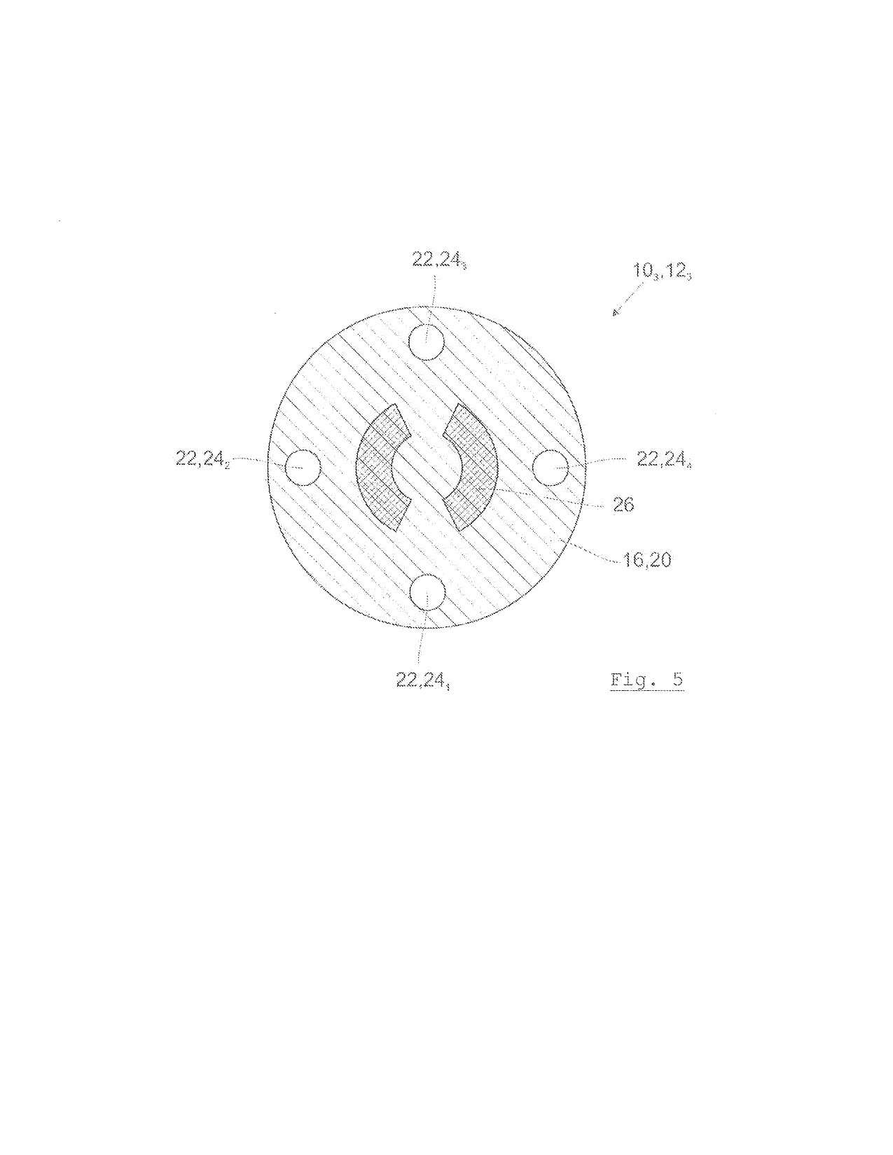

In FIG. 4, the apparatus 10₂ according to the invention in accordance with a second embodiment is shown by way of a sectional view along the lines of the sectional plane X-X defined in FIG. 1. The outlet openings 26 of the receptacle 12₂ according to the second embodiment have an identical structure to those of the first embodiment, with the first attachment unit 22, however, having an annular cross-section and surrounding the outlet openings 26.

In FIG. 5, the apparatus 10₃ according to the invention in accordance with a third embodiment is shown with the receptacle 12₃ by way of a sectional view along the lines of the sectional plane X-X defined in FIG. 1. The first attachment unit 22 comprises several, in this case four, first magnets 24, which are arranged uniformly distributed over the bottom wall 20 and radially outside the outlet opening 26.

### LIST OF REFERENCE NUMERALS

10₁-10₃ apparatus
12₁-12₃ receptacle
14 cartridge
16 wall
18 side wall
20 bottom wall
22 first attachment unit
24 first magnet
26 outlet opening
28 grating
30 first sealing element
32 positioning means
36 housing
37 top wall
38 interior space
39 second attachment unit
40 second magnet
42 magnetic or magnetised body
44 inlet opening
46 treatment means
48 second sealing element
50 outlet
A longitudinal axis

What is claimed is:

1. An apparatus for treating a liquid, comprising:
a receptacle for collecting the liquid to be treated, having a first attachment unit with a property that it develops a force of attraction under an influence of a magnet or with a property of the magnet; and
a cartridge, attachable to the receptacle in a releasable manner, for treating the liquid, having a second attachment unit with a property that it develops a force of attraction under the influence of the magnet or with the property of the magnet,
wherein the first attachment unit and the second attachment unit co-operate in such a manner that the cartridge is attachable to the receptacle in a releasable manner.

2. The apparatus according to claim 1, wherein at least one of the receptacle and the cartridge comprises a sealing element, and wherein the first attachment unit and the second attachment unit co-operate in such a manner and are adapted to the at least one sealing element in such a manner that the cartridge is sealable with respect to the receptacle in a liquid-tight manner.

3. The apparatus according to claim 1, wherein the first attachment unit is arranged centrally on the receptacle.

4. The apparatus according to claim 1, wherein the receptacle contains an outlet opening for releasing the liquid to be treated from the receptacle, and wherein the outlet opening at least partially surrounds the first attachment unit.

5. The apparatus according to claim 1, wherein the receptacle comprises an outlet opening for releasing the liquid to be treated from the receptacle, and wherein the first attachment unit at least partially surrounds the outlet opening.

6. The apparatus according to claim 1, wherein the first attachment unit comprises a first magnet having a circular annular cross-section.

7. The apparatus according to claim 1, wherein the first attachment unit comprises several magnets.

8. The apparatus according to claim 1, wherein the apparatus comprises at least one positioning element for defining the position of the cartridge relative to the receptacle.

9. The apparatus according to claim 1, wherein the second attachment unit is arranged centrally on the cartridge.

10. The apparatus according to claim 1, wherein the second attachment unit is arranged in a top wall of the cartridge.

11. The apparatus according to claim 10, wherein the second attachment unit is completely surrounded by the material of the top wall.

12. The apparatus according to claim 1, wherein the second attachment unit has a circular annular cross-section.

13. A receptacle for collecting a liquid to be treated, comprising: the first attachment unit according to claim 1 for attaching a cartridge for treating the liquid in a releasable manner to the receptacle.

14. A cartridge for treating a liquid, comprising the second attachment unit according to claim 1.

15. A method of releasably attaching a cartridge for treating a liquid to a receptacle for collecting the liquid to be treated, comprising the following steps:
providing a receptacle for collecting the liquid to be treated, having a first attachment unit with a property that it develops a force of attraction under an influence of a magnet or with a property of a magnet;
providing a cartridge for treating the liquid, having a second attachment unit with a property that it develops a force of attraction under an influence of the magnet or with a property of the magnet; and
releasably connecting the cartridge to the receptacle by the first attachment unit and the second attachment unit.

16. The apparatus according to claim 2, wherein the first attachment unit is arranged centrally on the receptacle, wherein the receptacle contains an outlet opening for releasing the liquid to be treated from the receptacle, and wherein the outlet opening at least partially surrounds the first attachment unit.

17. The apparatus according to claim 16, wherein the receptacle comprises an outlet opening for releasing the liquid to be treated from the receptacle, and wherein the first attachment unit at least partially surrounds the outlet opening, and wherein the first attachment unit comprises a first magnet having a circular annular cross-section.

18. The apparatus according to claim 17, wherein the first attachment unit comprises several magnets, and wherein the apparatus comprises at least one positioning element for defining the position of the cartridge relative to the receptacle.

19. The apparatus according to claim 18, wherein the second attachment unit is arranged centrally on the cartridge.

20. The apparatus according to claim 19, wherein the second attachment unit is completely surrounded by the material of the top wall, and wherein the second attachment unit has a circular annular cross-section.
